(19) United States
(12) Patent Application Publication
(10) Pub. No.: US 2022/0343202 A1
(43) Pub. Date: Oct. 27, 2022

(54) ARITHMETIC CIRCUIT, ARITHMETIC DEVICE, INFORMATION PROCESSING APPARATUS, AND METHOD FOR SEARCHING FOR GROUND STATE OF ISING MODEL

(71) Applicant: Hitachi, Ltd., Tokyo (JP)

(72) Inventors: Takuya OKUYAMA, Tokyo (JP); Masanao YAMAOKA, Tokyo (JP)

(21) Appl. No.: 17/635,736

(22) PCT Filed: Oct. 29, 2019
(86) PCT No.: PCT/JP2019/042433

§ 371 Date: Feb. 16, 2022

(51) Int. Cl. G06N 10/60

(52) U.S. Cl. CPC G06N 10/60

(57) ABSTRACT

An arithmetic circuit includes: a spin memory that stores a value indicating a state of one spin in an interaction model; an interaction coefficient auxiliary memory that stores an interaction coefficient of a subfunction corresponding to the spin memory; an external magnetic field coefficient auxiliary memory that stores an external magnetic field coefficient of the subfunction corresponding to the spin memory; a weight input line that receives a weight signal of the subfunction; an interaction coefficient calculation unit that calculates a weighted subfunction interaction coefficient by using the weight signal of the subfunction and the interaction coefficient of the subfunction; an external magnetic field coefficient calculation unit that calculates a weighted subfunction external magnetic field coefficient; and a next state calculation unit that calculates a next state of the spin based on the value of the spin, the weighted subfunction interaction coefficient, and the weighted subfunction external magnetic field coefficient.

### TECHNICAL FIELD

The present invention relates to an information processing apparatus, an arithmetic device, and an information processing method.

### BACKGROUND ART

PTL 1 discloses that “provided is a semiconductor device in which components serving as basic constituting units configured to obtain a solution of an interaction model are arranged in an array”, and “the semiconductor device includes a plurality of units, each of which includes: a first memory cell that stores a value indicating a state of one node of the interaction model; a second memory cell that stores an interaction coefficient indicating an interaction from another node connected to the one node; a third memory cell that stores a flag for fixing the value of the first memory cell; a first arithmetic circuit that decides a value indicating a next state of the one node based on a value indicating a state of the another node and the interaction coefficient; and a second arithmetic circuit that decides whether to record the value indicating the next state in the first memory cell according to a value of the flag”.

Non-PTL 1 describes minor-embedding in quantum annealing (adiabatic quantum optimization).

### CITATION LIST

### Patent Literature

PTL 1: JP-A-2016-51313

### Non-Patent Literature

Non-PTL 1: Choi, V. (2008). Minor-embedding in adiabatic quantum computation: I. The parameter setting problem. Quantum Information Processing, 7(5), 193-209.

### SUMMARY OF INVENTION

### Technical Problem

Many physical phenomena and social phenomena can be expressed by interaction models. The interaction model is defined by a plurality of nodes constituting the model, and interactions between the nodes, and bias for each node if necessary. Various models have been proposed in the fields of physics and social science, but all of the models can be interpreted as a form of interaction model.

One of the interaction models is an Ising model. Searching for a ground state of the Ising model is an optimization issue to find a spin alignment that minimizes an energy function of the Ising model. As a method for searching for a ground state of the Ising model, there is a method by using Markov chain Monte Carlo methods (hereinafter referred to as MCMC).

When a traveling salesman issue or a route search issue is to be solved as a ground state search issue of an interaction model, this energy function is generally represented by a linear sum of a plurality of terms, such as a penalty term that represents a constraint. Since an optimal value of a weight of each term is generally unknown, a solution is searched for while the weight is changed, and an exact solution or a good approximate solution is obtained.

In the related art, when an interaction model with a changed weight is to be solved, interaction model calculation has been performed outside a machine (host PC), and a result of the interaction model calculation has been written to the machine. However, as an issue scale increases, or when it is necessary to frequently switch the weight, the processing incurs a high calculation cost and a high communication cost. As a result, there is a problem that it is difficult to diversify parameters in optimization calculation and adjust a penalty coefficient for constrained optimization.

In view of the foregoing problems, an object of the invention is to provide an information processing apparatus and an information processing method capable of efficiently searching for a ground state of an Ising model.

### Solution to Problem

A preferred aspect of the invention relates to an arithmetic circuit including: a variable memory that stores a value indicating a state of one variable in an interaction model; an interaction coefficient auxiliary memory that stores an interaction coefficient of a subfunction corresponding to the variable memory; an external magnetic field coefficient auxiliary memory that stores an external magnetic field coefficient of the subfunction corresponding to the variable memory; a weight input line that receives a weight signal of the subfunction; an interaction coefficient calculation unit that calculates a weighted subfunction interaction coefficient by using the weight signal of the subfunction and the interaction coefficient of the subfunction; an external magnetic field coefficient calculation unit that calculates a weighted subfunction external magnetic field coefficient by using the weight signal of the subfunction and the external magnetic field coefficient of the subfunction; and a next state calculation unit that calculates a next state of the variable based on the value indicating the state of the variable, the weighted subfunction interaction coefficient, and the weighted subfunction external magnetic field coefficient.

In a more specific aspect of the invention, the interaction coefficient auxiliary memory stores interaction coefficients of K subfunctions (K is an integer of 2 or more), the external magnetic field coefficient auxiliary memory stores external magnetic field coefficients of the K subfunctions, the weight input line inputs weight signals of the K subfunctions, and the interaction coefficients of the K subfunctions, the external magnetic field coefficients of the K subfunctions, and the weight signals of the K subfunctions are associated with each other.

Another preferred aspect of the invention relates to an arithmetic device including N of the arithmetic circuits, in which the N arithmetic circuits correspond to N variables in the interaction model.

In a more specific aspect of the invention, the interaction coefficient calculation unit adds the K weighted subfunction interaction coefficients to obtain an interaction coefficient J_{i,j} in an energy function H(σ) of an Ising model, and the external magnetic field coefficient calculation unit adds the K weighted subfunction external magnetic field coefficients to obtain an external magnetic field coefficient hᵢ in the energy function H(σ) of the Ising model. A relation of Equation 1 to be described later holds, where σᵢ represents a value of an i-th variable, J_{i,j} represents an interaction coefficient between the i-th variable and a j-th variable, and hᵢ represents an external magnetic field coefficient acting on the i-th variable.

Still another preferred aspect of the invention relates to an information processing apparatus including: a processor; a main storage device; an auxiliary storage device; an input device; an output device; the arithmetic device; and a system bus connecting the devices.

Yet another preferred aspect of the invention relates to a method for searching for a ground state of an Ising model, by using an energy function H expressed by Equation 2 to be described later, where σᵢ is a value of an i-th spin, φₖ is a subfunction of a k-th term, and wₖ is a weight of the subfunction of the k-th term, and by using a plurality of spin units, each of the plurality of spin units including a first memory that stores the value σᵢ of the spin, a second memory that stores an interaction coefficient of the subfunction, and a third memory that stores an external magnetic field coefficient of the subfunction. The method includes: a first step of converting issue data into the Ising model; a second step of setting an interaction coefficient of each term of the subfunction in the second memory; a third step of setting an external magnetic field coefficient of each term of the subfunction in the third memory; a fourth step of setting a weight of each term of the subfunction; a fifth step of initializing the value of the spin in the first memory; and a sixth step of executing, by using the interaction coefficient in the second memory, the external magnetic field coefficient in the third memory, and the weight, an interaction operation to calculate a next state of the value of the spin.

In another specific aspect of the invention, the weight of each term of the subfunction is changed a plurality of times.

### Advantageous Effect

According to the invention, a ground state of an interaction model can be efficiently searched for. Other problems, configurations, and effects will be apparent from the following description of the embodiments.

### BRIEF DESCRIPTION OF DRAWINGS

FIG. 1 is a conceptual diagram of an energy landscape of an Ising model.

FIG. 2 is a block diagram showing a schematic configuration of an information processing apparatus.

FIG. 3 is a block diagram of an arithmetic circuit.

FIG. 4 is a functional block diagram showing main functions of the information processing apparatus.

FIG. 5 is a flowchart illustrating ground state search processing.

### DESCRIPTION OF EMBODIMENTS

Hereinafter, embodiments will be described in detail with reference to the drawings. In the following description, the same or similar elements are denoted by the common reference numerals, and a repetitive description thereof may be omitted. Where there are a plurality of elements having the same or similar functions, the elements may be described by adding different subscripts to the same reference numeral. In addition, when it is not necessary to distinguish the plurality of elements, the elements may be described by omitting the subscripts.

First, an Ising model will be described. The Ising model is a model of statistical dynamics to explain behaviors of a magnetic substance. The Ising model is defined by using a state of a spin taking two values of +1/−1 (which may be “0/1”, “up/down” or the like) and an interaction coefficient indicating an interaction between the spins. An energy function H(σ) of the Ising model (generally called Hamiltonian) is expressed by the following Equation 1.

$$\begin{matrix}[ Equation 1 ] & \\ H ( σ ) = - {\sum }_{i < j} {J}_{i , j} {σ}_{i} {σ}_{j} - {\sum }_{i < j} {h}_{i} {σ}_{i} & ( 1 )\end{matrix}$$

In the Equation 1, σᵢ represents a value of an i-th spin, J_{i,j} represents an interaction coefficient between the i-th spin and a j-th spin, and hᵢ represents an external magnetic field coefficient acting on the i-th spin. A matrix J and a vector h that collectively represent these parameters are introduced. In the matrix J, an element in an i-th row and a j-th column is J_{i,j}, and a diagonal component is 0. In addition, in the vector h, an i-th element is hᵢ.

A connection relation between the spins of the Ising model is represented by graph G=(V, E). The graph G is formed of a set V of vertexes and a set E of edges. V={v₁, . . . , v_{N}} is the set of vertexes, and the σᵢ of the spin of the Ising model is on each vertex vᵢ.

A right side of the Equation 1 represents a sum of energies resulting from interactions between the spins. Generally, the Ising model is expressed as an undirected graph and is not distinguished between an interaction from the i-th spin to the j-th spin and an interaction from the j-th spin to the i-th spin. Therefore, an influence of an interaction is obtained for a combination of σᵢ and σⱼ that satisfies i<j in the Equation 1.

Searching for a ground state of an Ising model is an optimization issue to find a spin alignment that minimizes an energy function of the Ising model. In the present embodiment, the ground state of the Ising model is searched for by using Markov chain Monte Carlo methods (hereinafter referred to as MCMC).

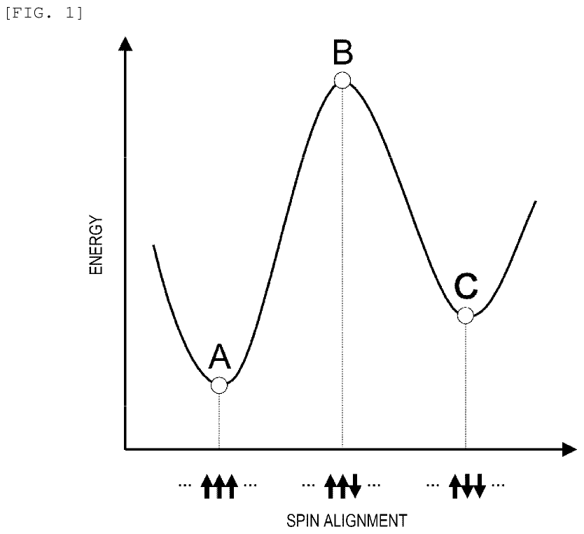

FIG. 1 is a conceptual diagram of an energy landscape of the Ising model. A horizontal axis of the graph represents a spin alignment, and a vertical axis thereof represents a total energy of a system. In probabilistic transitions, a probabilistic transition from a current state σ to a state σ′ near the state σ is repeated. A probability of transitioning from the state σ to the state σ′ is hereinafter referred to as a transition probability P (σ, σ′). Examples of the transition probability P (σ, σ′) include those obtained by a metropolis method and those obtained by a heat bath method.

As a method for generating the state σ′ near the current state σ, a method of changing a value of one spin from the current state σ is common. By changing spins to be changed one by one, a state where all the spins can be taken is searched for. For example, in a case of FIG. 1, one spin is inverted from a state A to be in a state B, and is further inverted to be in a state C.

In a case of performing the MCMC while gradually reducing a temperature T from a large value, energy asymptotically converges to the lowest state. A method for finding an optimal solution or an approximate solution of a minimization issue by using the above technique includes simulated annealing (hereinafter referred to as SA) and momentum annealing (hereinafter referred to as MA).

When the MCMC or the SA or the MA is applied to the Ising model, the value of the spin is determined based on a probabilistic behavior such as the following Equation 2. For example, as described in PTL 1, the processing speed can be increased by preparing a plurality of circuits that implement probabilistic processing based on the Equation 2 and updating values of a plurality of spins in parallel.

As shown below, an energy function H is mostly represented by a sum of a plurality of terms φ representing a particular meaning. w represents a weight of a term and k represents the number of the term.

$$\begin{matrix}[ Equation 2 ] & \\ H ( σ ) = {\sum }_{k} {w}_{k} \cdot {ϕ}_{k} ( σ ) & ( 2 )\end{matrix}$$

For example, a traveling salesman issue in N cities is formulated as a ground state search issue of an Ising model. In this case, a spin σ_{t,n} is a binary variable representing whether to visit a city n at in the t-th visitation order. Factors to be considered in formulation include 3 terms of (1) a term representing a movement distance, (2) a term representing a constraint of “visiting only one place at a time”, and (3) a term representing a constraint of “visiting each city only once”. When respective terms are represented as φ₁(σ), φ₂(σ), and φ₃(σ), an energy function of an Ising model required to solve the traveling salesman issue is

H=φ₁(σ)+λ(φ₂(σ)+φ₃(σ))

λ is a sufficiently large value called a penalty coefficient. As shown in the Equation 2, the energy function of the Ising model is expressed as an energy function by a sum of a plurality of terms representing particular meanings. This applies not only to the traveling salesman issue, but also to various combinatorial optimization issues.

The penalty coefficient λ representing strength of a constraint must be sufficiently large such that the penalty coefficient λ is equal to or larger than a threshold value. Meanwhile, when λ is too large, a height of an energy wall shown in FIG. 1 is increased, and a transition between states is difficult, and thus an exact solution or a good approximate solution cannot be obtained. Therefore, in order to obtain a solution within a practical time, it is necessary to set λ to an appropriate value.

Generally, it is difficult to calculate an appropriate λ in advance. Therefore, it is preferable to execute a solution search under each λ while changing the value of λ. When A is changed, a new energy function is calculated by a host PC outside a dedicated computer. However, it is not preferable because it causes an increase in calculation time. Therefore, in the present embodiment, in order to solve the issue, an information processing apparatus and a calculation flow suitable for issue reconstruction are provided.

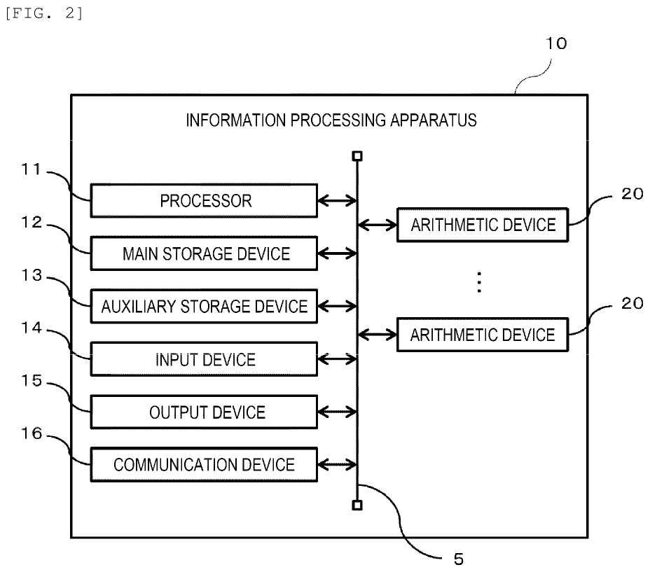

FIG. 2 is an example of the information processing apparatus that searches for the ground state of the Ising model. As shown in the same figure, an information processing apparatus 10 includes a processor 11, a main storage device 12, an auxiliary storage device 13, an input device 14, an output device 15, a communication device 16, one or more arithmetic devices 20, and a system bus 5 communicably connecting the devices. The information processing apparatus 10 may be implemented by using, for example, a virtual information processing resource such as a cloud server partly or entirely provided by a cloud system. Further, the information processing apparatus 10 may be implemented by, for example, a plurality of information processing apparatuses that are communicably connected and are operated in cooperation with each other.

The processor 11 is configured by using, for example, a central processing unit (CPU) or a micro processing unit (MPU). The main storage device 12 is a device that stores programs and data, and is, for example, a read only memory (ROM) (a static random access memory (SRAM), a nonvolatile RAM (NVRAM), a mask read only memory (mask ROM), a programmable ROM (PROM) or the like), and a random access memory (RAM) (dynamic random access memory (DRAM) or the like). The auxiliary storage device 13 is a hard disk drive, a flash memory, a solid state drive (SSD), an optical storage device (compact disc (CD), digital versatile disc (DVD) or the like), or the like. The programs and data stored in the auxiliary storage device 13 are read into the main storage device 12 at any time.

The input device 14 is a user interface that receives an input of information from a user, and is, for example, a keyboard, a mouse, a card reader, and a touch panel. The output device 15 is a user interface that provides information to the user, and is, for example, a display device (liquid crystal display (LCD), graphic card or the like) that visualizes various information, an audio output device (speaker), and a printing device. The communication device 16 is a communication interface that communicates with other devices, and is, for example, a network interface card (NIC), a wireless communication module, a universal serial interface (USB) module, and a serial communication module.

The arithmetic device 20 is a device that executes processing related to searching for the ground state of the Ising model. The arithmetic device 20 may take a form of an expansion card to be mounted on the information processing apparatus 10, such as a graphics processing unit (GPU). The arithmetic device 20 is formed of hardware such as a complementary metal oxide semiconductor (CMOS) circuit, a field programmable gate array (FPGA), and an application specific integrated circuit (ASIC). The arithmetic device 20 includes a control device, a storage device, and an interface that connects to the system bus 5, and transmits/receives a command and information to/from the processor 11 via the system bus 5. The arithmetic device 20 may be communicably connected to another arithmetic device 20 via, for example, a communication line, and may be operated in cooperation with another arithmetic device 20. A function implemented by the arithmetic device 20 may be implemented by, for example, causing a processor (CPU, GPU or the like) to execute a program.

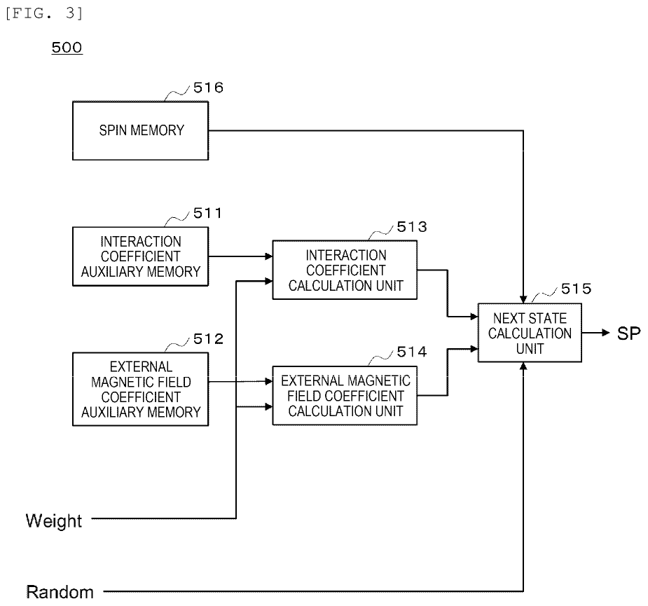

The arithmetic device 20 shown in FIG. 2 will be described later in FIG. 3. One or more arithmetic devices 20 can be mounted.

FIG. 3 is a diagram illustrating an operating principle of the arithmetic device 20, and is a block diagram of a circuit constituting the arithmetic device 20 (hereinafter referred to as an arithmetic circuit 500). The arithmetic circuit 500 implements a function of probabilistically determining the value of the spin according to a standard such as a metropolis method. The arithmetic circuit 500 includes a spin memory that stores a value of one spin and a circuit that calculates the value of the spin. A plurality of arithmetic circuits 500 are mounted on the arithmetic device 20 and can be operated in parallel. Hereinafter, there are K subfunctions of φ₁, . . . , φ_{K} that constitute the energy function H, and each subfunction can be expressed by Equation 3.

$$\begin{matrix}[ Equation 3 ] & \\ {ϕ}_{k} ( σ ) = - {\sum }_{i < j} {J}_{i , j}^{k} {σ}_{i} {σ}_{j} - {\sum }_{i < j} {h}_{i}^{k} {σ}_{i} & ( 3 )\end{matrix}$$

An interaction coefficient J^{K}ᵢⱼ included in the subfunction is stored by an interaction coefficient auxiliary memory 511, and an external magnetic field coefficient h^{K}ᵢ is stored by an external magnetic field coefficient auxiliary memory 512.

The Equation 3 is substituted into the Equation 2, and thereby Equation 4 is obtained.

$$\begin{matrix}[ Equation 4 ] & \\ H ( σ ) = {{\sum }_{k = 1}}^{K} {w}_{k} [ - {\sum }_{i < j} {J}_{i , j}^{k} {σ}_{i} {σ}_{j} - {\sum }_{i < j} {h}_{i}^{k} {σ}_{i} ] & ( 4 )\end{matrix}$$

When the Equation 4 is compared with Equation 1, the following relational expression is obtained.

[Equation 5]

J_{i,j}=−Σₖ₌₁^{K}wₖJ_{i,j}^{k} (5)

[Equation 6]

hᵢ=−Σₖ₌₁^{K}wₖhᵢ^{k} (6)

That is, when weights w₁, . . . , w_{K} of terms are given, an interaction coefficient Jᵢⱼ and an external magnetic field coefficient hᵢ of the energy function H can be calculated by a product-sum operation of each coefficient and each weight of the subfunction. A signal Weight in FIG. 3 includes the weights w₁, . . . , w_{K} of the subfunction. Then, an interaction coefficient calculation unit 513 performs calculation corresponding to Equation 5, and an external magnetic field coefficient calculation unit 514 performs calculation corresponding to Equation 6. Since these calculations can be performed in parallel for each interaction and spin, a parallel circuit may be provided to perform these calculations.

After the interaction coefficient Jᵢⱼ and the external magnetic field coefficient hᵢ are obtained, an issue is the same as the issue of solving the Equation 1, and therefore, for example, the configuration described in PTL 1 may be used to determine a next state of the spin. Generally, when a spin value is to be updated based on the MCMC, random numbers are required to determine the next state, and in FIG. 3, a signal Random supplies this random number sequence. In addition, a current state of the spin value is stored in a spin memory 516, and this value is also used for determining the next state. A next state calculation unit 515 determines next states of all spins based on the above information. Similar to the interaction coefficient calculation unit 513 and the external magnetic field coefficient calculation unit 514, the next state calculation unit 515 can also calculate independently for each spin, and speeding up due to parallelization can be expected.

As described above, high-speed calculation is possible by forming the arithmetic circuits 500, as one spin unit, in an array pattern on the arithmetic device 20 and performing parallel calculation of a plurality of spins. Each of the arithmetic circuits 500 calculates and stores a value of one spin.

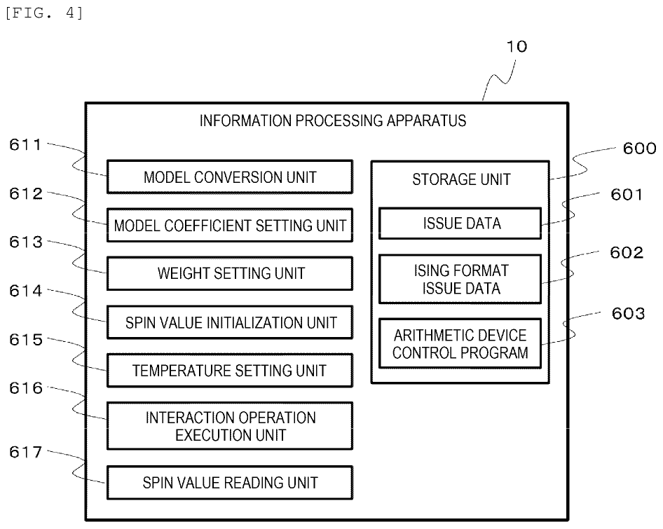

FIG. 4 shows main functions (software configuration) of the information processing apparatus 10. As shown in the same figure, the information processing apparatus 10 includes a storage unit 600, a model conversion unit 611, a model coefficient setting unit 612, a weight setting unit 613, a spin value initialization unit 614, a temperature setting unit 615, an interaction operation execution unit 616, and a spin value reading unit 617. These functions are implemented by the processor 11 reading and executing the programs stored in the main storage device 12, or by the hardware of the arithmetic device 20. In addition to the above functions, the information processing apparatus 10 may have other functions of an operating system, a file system, a device driver, or a database management system (DBMS).

Among the above functions, the storage unit 600 stores issue data 601, Ising format issue data 602, and an arithmetic device control program 603 in the main storage device 12 or the auxiliary storage device 13. The issue data 601 is data indicating, for example, combinatorial optimization issues or the like in a predetermined description format. The issue data 601 is set by, for example, the user via a user interface (an input device, an output device, a communication device or the like). The Ising format issue data 602 is data generated by the model conversion unit 611 converting the issue data 601 into data in an Ising model format. The arithmetic device control program 603 is a program executed when the interaction operation execution unit 616 controls the arithmetic device 20, or loaded into each arithmetic device 20 by the interaction operation execution unit 616 and executed by the arithmetic device 20.

The model conversion unit 611 converts the issue data 601 into the Ising format issue data 602, which is the data in an Ising model format. A function of the model conversion unit 611 does not necessarily be implemented in the information processing apparatus 10, and the information processing apparatus 10 may take in, via the input device 14 or the communication device 16, the Ising format issue data 602 generated by another information processing apparatus or the like.

The model coefficient setting unit 612 sets, in the interaction coefficient auxiliary memory 511, an adjacency matrix J indicating an interaction relation of the Ising model based on the Ising format issue data 602, and sets, in the external magnetic field coefficient auxiliary memory 512, the vector h representing the external magnetic field coefficient.

The spin value initialization unit 614 initializes the value of each spin stored in the spin memory 516 of the arithmetic circuit 500 in the arithmetic device 20. The spin value initialization unit 614 sets, to “1” or “−1” with a probability of 50%, both values σ^{L}₁, . . . , σ^{L}_{N} of spins in a first spin group and values σ^{R}₁, . . . , σ^{R}_{N} of spins in a second spin group in a complete bipartite graph, for example.

The temperature setting unit 615 sets a value of the temperature T used when the interaction operation execution unit 616 searches for the ground state of the Ising model.

The interaction operation execution unit 616 performs an operation (hereinafter referred to as an interaction operation) for searching for the ground state of the Ising model for each temperature T set by the temperature setting unit 615. In the interaction operation, the interaction operation execution unit 616 changes, for example, the temperature T from a high temperature to a lower temperature.

When searching for the ground state of the Ising model by the interaction operation execution unit 616 is completed, the spin value reading unit 617 reads the values of the spins stored in the spin memory 516, and outputs the read values to the output device 15 or the communication device 16.

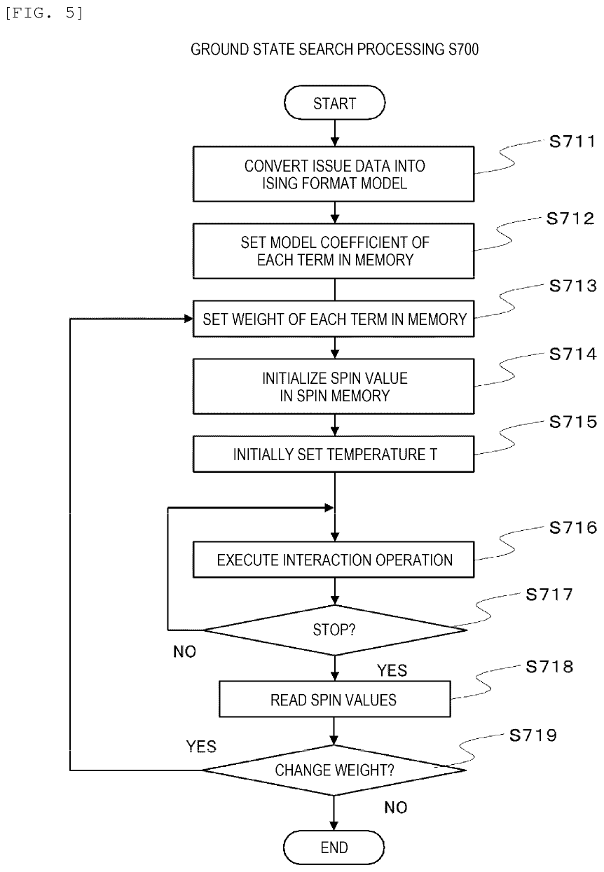

FIG. 5 is a flowchart illustrating processing performed by the information processing apparatus 10 in a case of searching for the ground state of the Ising model (hereinafter referred to as ground state search processing S700). Hereinafter, the ground state search processing S700 will be described with reference to the same figure. It should be noted that the letter “S” prefixed to a reference sign indicates a step of processing. The ground state search processing S700 is started by, for example, receiving an instruction from the user via the input device 14.

As shown in the same figure, firstly, the model conversion unit 611 converts the issue data 601 into the Ising format issue data 602 (S711). When the storage unit 600 has stored the Ising format issue data 602, the processing S711 is omitted. The processing in S711 and processing after S712 may be executed by different devices. In addition, the processing in S711 and the processing after S712 may be executed at different timings (for example, it is conceivable that the processing in S711 is performed in advance).

Subsequently, the model coefficient setting unit 612 sets, in the interaction coefficient auxiliary memory 511 and the external magnetic field coefficient auxiliary memory 512, values of the interaction coefficient J^{K}ᵢⱼ and the external magnetic field coefficient h^{K}ᵢ included in the subfunction (S712). The values in the memories can also be set or edited by the user via a user interface (for example, implemented by the input device 14, the output device 15, the communication device 16 or the like).

Subsequently, the weight setting unit 613 reads the weights w₁, . . . , w_{K} of the terms from the storage unit 600, and determines a value of the signal Weight (S713). The interaction coefficient, the external magnetic field coefficient, and the weight are set to values according to the Ising model in each of the arithmetic circuits 500 formed in an array pattern on the arithmetic device 20.

Subsequently, the spin value initialization unit 614 initializes the value of each spin stored in the spin memory 516 (S714). In initialization, for example, a value of +1 or −1 is randomly set.

Subsequently, the temperature setting unit 615 sets a parameter Tₘ (m=1, 2, 3, . . . ) used in an annealing method, which is referred to as a temperature (S715). The above subscript m represents the type of the temperature T to be set.

Subsequently, the interaction operation execution unit 616 generates the next state by the next state calculation unit 515 (S716). The interaction operation execution unit 616 supplies the signal Weight to each of the arithmetic circuits 500, and the arithmetic circuit 500 generates the next state based on the interaction coefficient, the external magnetic field coefficient, and the weight. The calculation in this case is as described in the Equation 1, the Equation 5, and the Equation 6.

In the above description, the weights w₁, . . . , w_{K} are transmitted from the interaction operation execution unit 616 to the arithmetic circuit 500 each time the next state is calculated. As another example, a weight memory that stores a weight is provided in the arithmetic circuit 500, the interaction operation execution unit 616 stores the weight in the weight memory, and then the weight may be read from the memory to calculate the next state. In this way, transmission of the weight from the interaction operation execution unit 616 to the arithmetic circuit 500 can be omitted, and burden on a host device can be reduced.

In addition, a coefficient storage memory that stores a coefficient may be provided in the arithmetic circuit 500, and the interaction coefficient calculation unit 513 and the external magnetic field coefficient calculation unit 514 may perform calculations in the Equation 5 and the Equation 6, and then results may be stored in the coefficient storage memory, and the next state calculation unit 515 may read the coefficients Jᵢⱼ and hᵢ from the memory to calculate the next state. In this way, burden of calculating the coefficients each time the next state is calculated can be reduced.

Subsequently, the interaction operation execution unit 616 determines whether a stop condition is satisfied (for example, whether the temperature T has reached a preset minimum temperature) (S717). When the interaction operation execution unit 616 determines that the stop condition is satisfied (YES in S717), the processing proceeds to S718. Meanwhile, when the interaction operation execution unit 616 determines that the stop condition is not satisfied (NO in S717), the processing returns to S716.

In S718, the spin value reading unit 617 reads the values of the spins stored in the spin memory 516 and outputs the values. The user who sees the output result can determine whether to change the weight of the subfunction and can change the weight if necessary (YES in S719). When it is not necessary to change the weight, the ground state search processing S700 is ended (NO in S719).

The output result can be confirmed by the output device 15. In the present embodiment, the weight setting unit 613 can change the value of the signal Weight by changing the weights w₁, . . . , w_{K} in the storage unit 600 or by selecting from a plurality of prepared ones. Accordingly, a weight of a subfunction φₖ can be changed from the outside of the arithmetic circuit 500. Therefore, it is easy to change the weight of the subfunction according to a result of the ground state search processing S700. Alternatively, it is also possible to change the weight of the subfunction under a predetermined condition, automatically perform a plurality of ground state search processing S700, and select a preferable one from a plurality of obtained results. In order to implement the above function, it is desirable that the information processing apparatus 10 causes the output device 15 to display a graphical user interface (GUI) for setting the weight of the subfunction φₖ. A function of the GUI may be a part of the function of the weight setting unit 613.

The GUI can, for example, allow the user to select a weight prepared in advance and automatically execute a plurality of types of ground state searches by a plurality of types of weights. The user can select a good one from a plurality of types of results.

As described above in detail, according to the information processing apparatus 10 in the present embodiment, the ground state of the Ising model can be efficiently searched for. Therefore, the combinatorial optimization issues can be efficiently solved. Since the information processing apparatus 10 (including the arithmetic device 20) has a simple structure, the information processing apparatus 10 can be manufactured inexpensively and conveniently.

One embodiment has been described above, but the invention is not limited to the above embodiment, and various modifications can be made without departing from the gist of the invention. For example, the above embodiment has been described in detail for easy understanding of the invention, and is not necessarily limited to those including all the configurations described above. Another configuration can be added to, eliminated from, or replaced with a part of the configurations of the above embodiment.

A part of or all of the above configurations, functional units, processing units, processing methods, and the like may be implemented by hardware, for example, by designing with an integrated circuit. The above configurations, functions, and the like may be implemented by software by a processor interpreting and executing programs that implement the respective functions. Information such as a program, a table, and a file for implementing each function can be placed in a recording device such as a memory, a hard disk, or a solid state drive (SSD), or in a recording medium such as an IC card, an SD card, or a DVD.

In addition, the above drawings show control lines and information lines considered as necessary for description but do not show all the control lines and information lines that are mounted. For example, it may be considered that almost all the configurations are actually connected to each other.

Further, arrangements of various functional units, various processing units, and various databases of the information processing apparatus 10 described above are merely examples. The arrangement forms of the various functional units, the various processing units, and the various databases can be changed to optimum arrangement forms from viewpoints of performance, processing efficiency, communication efficiency, and the like of hardware and software of the information processing apparatus 10.

A configuration (schema or the like) of the database storing various types of data can be flexibly changed from viewpoints of efficient utilization of resources, improvement of processing efficiency, improvement of access efficiency, improvement of search efficiency or the like.

In the above embodiment, the calculation of the spin of the Ising model has been described as an example. The spin of the Ising model is generally treated as binary, but this embodiment can also be applied when an entity of the interaction model is expressed by a variable with three or more values. An example, in which the value of the spin of the Ising model is extended such that the value of the spin can be expressed in a state of three or more values, can be found in JP-A-2016-51314. In this case, the spin memory 516 in the embodiment may be changed such that three or more values can be stored.

### INDUSTRIAL APPLICABILITY

The invention can be used for an information processing apparatus, an arithmetic device, and an information processing method.

### REFERENCE SIGN LIST

10 information processing apparatus
11 processor
12 main storage device
20 arithmetic device
511 interaction coefficient auxiliary memory
512 external magnetic field coefficient auxiliary memory
513 interaction coefficient calculation unit
514 external magnetic field coefficient calculation unit
515 next state calculation unit
516 spin memory
600 storage unit
601 issue data
602 Ising format issue data
603 arithmetic device control program
611 model conversion unit
612 model coefficient setting unit
613 weight setting unit
614 spin value initialization unit
615 temperature setting unit
616 interaction operation execution unit
617 spin value reading unit

1. An arithmetic circuit comprising:
a variable memory that stores a value indicating a state of one variable in an interaction model;
an interaction coefficient auxiliary memory that stores an interaction coefficient of a subfunction corresponding to the variable memory;
an external magnetic field coefficient auxiliary memory that stores an external magnetic field coefficient of the subfunction corresponding to the variable memory;
a weight input line that receives a weight signal of the subfunction;
an interaction coefficient calculation unit that calculates a weighted subfunction interaction coefficient by using the weight signal of the subfunction and the interaction coefficient of the subfunction;
an external magnetic field coefficient calculation unit that calculates a weighted subfunction external magnetic field coefficient by using the weight signal of the subfunction and the external magnetic field coefficient of the subfunction; and
a next state calculation unit that calculates a next state of the variable based on the value indicating the state of the variable, the weighted subfunction interaction coefficient, and the weighted subfunction external magnetic field coefficient.

2. The arithmetic circuit according to claim 1, wherein
the interaction coefficient auxiliary memory stores interaction coefficients of K subfunctions (K is an integer of 2 or more),
the external magnetic field coefficient auxiliary memory stores external magnetic field coefficients of the K subfunctions,
the weight input line inputs weight signals of the K subfunctions, and
the interaction coefficients of the K subfunctions, the external magnetic field coefficients of the K subfunctions, and the weight signals of the K subfunctions are associated with each other.

3. The arithmetic circuit according to claim 2, wherein
the interaction coefficient calculation unit calculates K weighted subfunction interaction coefficients by using the weight signals of the subfunctions and the interaction coefficients of the subfunctions associated with each other, and
the external magnetic field coefficient calculation unit calculates K weighted subfunction external magnetic field coefficients by using the weight signals of the subfunctions and the external magnetic field coefficients of the subfunctions associated with each other.

4. An arithmetic device comprising:
N of the arithmetic circuits according to claim 3, wherein
the N arithmetic circuits correspond to N variables in the interaction model.

5. The arithmetic device according to claim 4, wherein
the interaction coefficient calculation unit adds the K weighted subfunction interaction coefficients to obtain an interaction coefficient J_{i,j} in an energy function H(σ) of an Ising model, and
the external magnetic field coefficient calculation unit adds the K weighted subfunction external magnetic field coefficients to obtain an external magnetic field coefficient hᵢ in the energy function H(σ) of the Ising model,
$$H ( σ ) = - {\sum }_{i < j} {J}_{i , j} {σ}_{i} {σ}_{j} - {\sum }_{i < j} {h}_{i} {σ}_{i} \qquad [ Equation 1 ]$$
where σᵢ represents a value of an i-th variable, J_{i,j} represents an interaction coefficient between the i-th variable and a j-th variable, and hᵢ represents an external magnetic field coefficient acting on the i-th variable.

6. An information processing apparatus comprising:
a processor;
a main storage device;
an auxiliary storage device;
an input device;
an output device;
the arithmetic device according to claim 4; and
a system bus connecting the devices.

7. The information processing apparatus according to claim 6, wherein
the output device displays a GUI for setting the weight signal of the subfunction.

8. A method for searching for a ground state of an Ising model by using an energy function expressed by
$$H ( σ ) = {\sum }_{k} {w}_{k} \cdot {ϕ}_{k} ( σ ) \qquad [ Equation 2 ]$$
where σᵢ is a value of an i-th spin, σₖ is a subfunction of a k-th term, and wₖ is a weight of the subfunction of the k-th term, and
by using a plurality of spin units, each of the plurality of spin units including a first memory that stores the value σᵢ of the spin, a second memory that stores an interaction coefficient of the subfunction, and a third memory that stores an external magnetic field coefficient of the subfunction,
the method comprising:
a first step of converting issue data into the Ising model;
a second step of setting an interaction coefficient of each term of the subfunction in the second memory;
a third step of setting an external magnetic field coefficient of each term of the subfunction in the third memory;
a fourth step of setting a weight of each term of the subfunction;
a fifth step of initializing the value of the spin in the first memory; and
a sixth step of executing, by using the interaction coefficient in the second memory, the external magnetic field coefficient in the third memory, and the weight, an interaction operation to calculate a next state of the value of the spin.

9. The method for searching for a ground state of an Ising model according to claim 8, wherein
in the fourth step, a GUI is used to allow a user to set the weight of each term of the subfunction.

10. The method for searching for a ground state of an Ising model according to claim 8, wherein
after the sixth step, the method returns to the fourth step and the weight of each term of the subfunction is changed, and the fifth step and the sixth step are executed again.

11. The method for searching for a ground state of an Ising model according to claim 10, wherein
the weight of each term of the subfunction is changed a plurality of times.
